(19) United States
(12) Patent Application Publication
(10) Pub. No.: US 2018/0341271 A1
(43) Pub. Date: Nov. 29, 2018

(54) ENVIRONMENT EXPLORATION SYSTEM AND METHOD

(71) Applicant: ANTS TECHNOLOGY (HK) LIMITED, HONG KONG (HK)

(72) Inventor: Ilya BLAYVAS, Rehovot (IL)

(73) Assignee: ANTS TECHNOLOGY (HK) LIMITED

(21) Appl. No.: 15/607,559

(22) Filed: May 29, 2017

(51) Int. Cl. G05D 1/02; G10L 15/18; G06K 9/00; B25J 9/00

(52) U.S. Cl. CPC G05D 1/0246; G10L 15/1822; B25J 9/0003; G05D 1/0274; G06K 9/00691

(57) ABSTRACT

An environment exploration method and system, the method comprising maintaining a database of object categories by: receiving sensory data from sensors of an autonomic machine and obtaining from the sensory data features of objects; and associating the obtained sensory data with corresponding object categories of the database, wherein the database stores a plurality of object categories associated with corresponding category features; identifying categories of objects and the corresponding category features relevant to a required task; calculating a work plan with a preferred set of operations for execution of the task based on the identified features; and generating and transmitting to actuators of the autonomic machine instructions to perform the calculated preferred set of operations.

### TECHNICAL FIELD

The present disclosure generally relates to environmental exploration by autonomic machines, and more specifically to task-performing robots.

### BACKGROUND

Known methods for robotic exploration usually use Simultaneous Localization And Mapping (SLAM), where the robot creates a map of new environment by exploring the new regions and simultaneously uses the map of the known regions for navigation and exploration.

### SUMMARY

According to one aspect of some embodiments of the present invention, there is provided an environment exploration method including: maintaining a database of object categories by: receiving sensory data from sensors of an autonomic machine and obtaining from the sensory data features of objects and associating the obtained sensory data with corresponding object categories of the database, wherein the database stores a plurality of object categories associated with corresponding category features, identifying categories of objects and the corresponding category features relevant to a required task, calculating a work plan with a preferred set of operations for execution of the task based on the identified features, and generating and transmitting to actuators of the autonomic machine instructions to perform the calculated preferred set of operations.

Optionally, the method includes attributing the features obtained from the sensory data to the associated object category.

Optionally, the method includes receiving the required command from a user, interpreting the command by a Natural Language Processor (NLP), validating the feasibility of the work plan and requesting a user to confirm the work plan.

Optionally, calculating a work plan including decomposing the task into a hierarchic set of operations based on the identified category features.

Optionally, the method includes determining if the obtained object features belongs to a related object category of the database, and in case a related object category is found in the database, tagging the corresponding sensory data with a corresponding object category identification and storing the tagged sensory data.

Optionally, in case a related object category is not found in the database, creating a new object category, tagging the corresponding sensory data with an identification of the new category and storing the tagged sensory data.

Optionally, in case the set of features identified in the sensory data includes additional features further to the features of the found category, creating an object sub-category that includes these additional features, tagging these additional features with the identification of the created sub-category and storing the tagged sensory data.

Optionally, the database of object categories stores categories of physical objects and categories of conceptual objects.

Optionally, the conceptual objects are potential goals of tasks.

Optionally, the database includes relations between object categories, wherein different types or levels of relations are indicated differently in the database, wherein each relation between object categories has a weight value according to the strength or type of the connection.

Optionally, the weight value of relation between object categories represents the probability that objects from the respective categories are related.

Optionally, the weight value dynamically changes based on current events or conditions.

According to one aspect of some embodiments of the present invention, there is provided an environment exploration system including: a database of object categories storing a plurality of object categories associated with corresponding category features, an autonomic machine having sensors and actuators, and a processor configured to: receive sensory data from the sensors of the autonomic machine and obtain from the sensory data features of objects, associate the obtained sensory data with corresponding object categories of the database, identify categories of objects and the corresponding category features relevant to a required task, calculate a work plan with a preferred set of operations for execution of the task based on the identified features, and generate and transmit to the actuators of the autonomic machine instructions to perform the calculated preferred set of operations.

### BRIEF DESCRIPTION OF THE DRAWINGS

Some non-limiting exemplary embodiments or features of the disclosed subject matter are illustrated in the following drawings.

In the drawings:

FIG. 1 is a schematic illustration of an environment exploration system according to some embodiments of the present invention;

FIG. 2 is a schematic flowchart illustrating a method for environment exploration according to some embodiments of the present invention;

FIG. 3 is a schematic graph illustration of an exemplary portion of an object database, according to some embodiments of the present invention;

FIG. 4 is a schematic flowchart illustrating a method for executing a task according to some embodiments of the present: invention; and

FIG. 5 is a schematic illustration of a task work plan, showing a task decomposed into a set of operations, according to some embodiments of the present invention.

With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

### DETAILED DESCRIPTION

Some embodiments of the present invention may include a system, a method, and/or a computer program product. The computer program product may include a tangible non-transitory computer readable storage medium (or media) having computer readable program instructions thereon for causing a processor to carry out aspects of the present invention. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including any object oriented programming language and/or conventional procedural programming languages.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

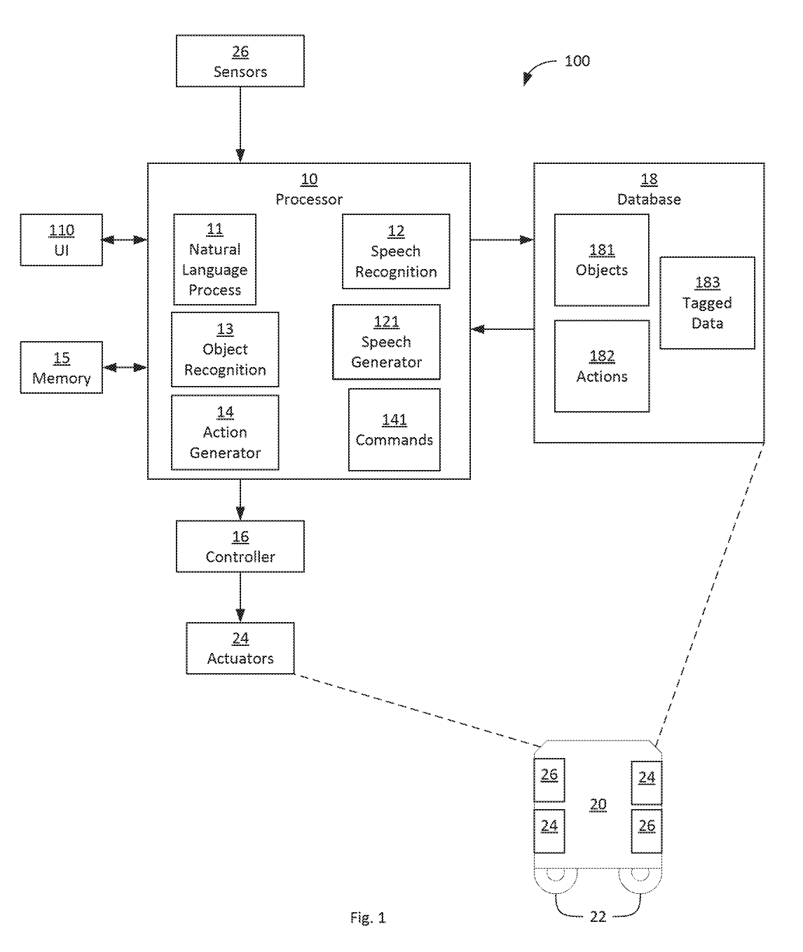

Reference is now made to FIG. 1, which is a schematic illustration of an environment exploration system 100 according to some embodiments of the present invention. System 100 may include an autonomic machine 20, such as a mobile robot, a domestic robot and/or an automatic guided vehicle. Autonomic machine 20 may include, communicate with and/or be controlled by a processor 10, a memory 15, a controller 16 and/or database 18.

Autonomic machine 20 may include a locomotive actuator 22, such as, for example, wheels, tracks, legs, and/or any other suitable locomotive actuator. Additionally, autonomic machine 20 may include a plurality of actuators 24 that facilitate a plurality of operations and/or tasks performable by machine 20, and a plurality of sensors 26 that may sense data about the environment of machine 20. Sensors 26 may include, for example, vision sensors, 3D scanners, Light Distance And Range (LIDAR) scanners, Sonic Range (SONAR) scanners, and/or any other suitable environmental sensor. In some embodiments of the present invention, autonomic machine 20 may be a domestic robot configured to perform domestic chores such as, for example, cleaning, cooking, tidying up, laundry chores, and/or any other suitable chores.

Autonomic machine 20 may move by locomotive actuator 22 in a certain environment which may be, for example, a domestic or a natural environment, and may perform tasks in the environment by actuators 24. Processor 10 may transmit instructions to controller 16, which in turn may control actuators 24 and 22 by generating controlling signals and transmitting the controlling signals to actuators 24 and 22. Processor 10 may generate the instructions, for example, based on pre-programmed and/or learned instructions. Actuators 24 may include, for example, wheel actuators, arm actuators, display actuators, loudspeaker actuators, and/or any other suitable motor and/or controller.

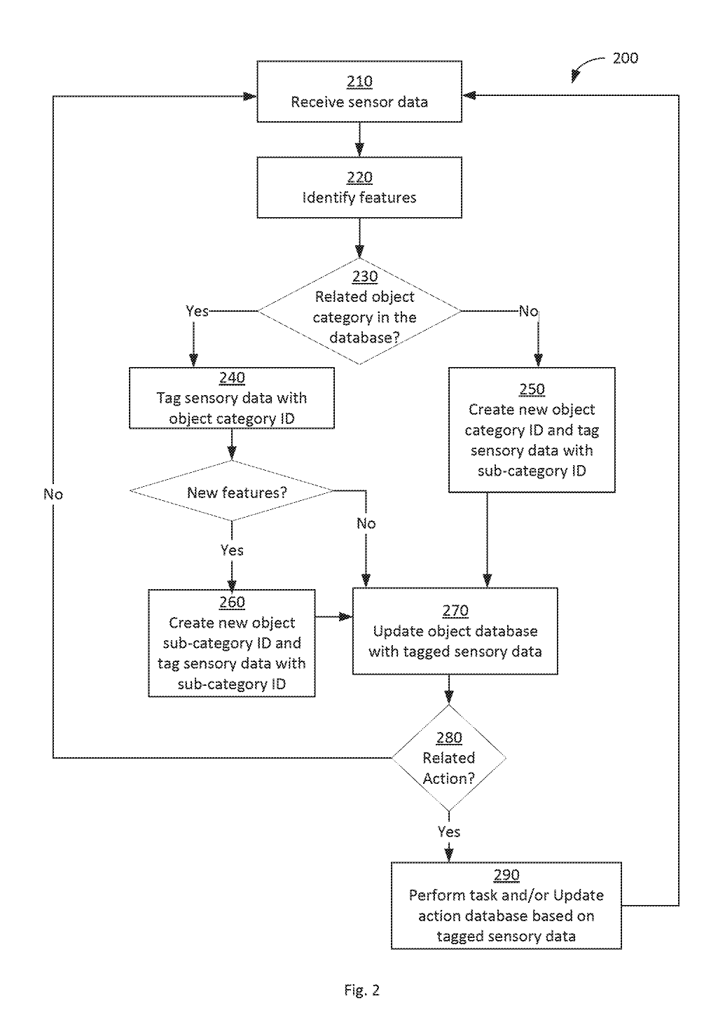

Reference is further made to FIG. 2, which is a schematic flowchart illustrating a method 200 for environment exploration according to some embodiments of the present invention. In some embodiments of the present invention, as indicated in block 210 processor 10 may receive and gather data from sensors 26, for example while moving and/or performing actions. Processor 10 may integrate the data received from sensors 26 to obtain information about the environment of autonomic machine 20 and objects in this environment. Processor 10 may use the gathered data, for example in conjunction with pre-stored data, for creation of a multi-layered map stored in database 18, further used for navigation and actions by autonomic machine 20.

As indicated in block 220, processor 10 may identify in received sensory data features of objects located in the explored environment. In some embodiments of the present invention, processor 10 may create and update the map and perform the feature recognition by navigating in the explored environment by machine 20, constantly receiving and processing the sensory data, tracking changes in the created map, and/or performing pattern and/or object recognition.

Database 18 may include inter-related object database 181 and task database 182. Object database 181 may store hierarchic object categories, each having a corresponding unique identification (ID) and stored along with tags indicative of respective features of the object category and relations to other objects. Each of the hierarchic object categories defines an object kind, for example objects that have a certain set of features, i.e. the category features. The category features may be used by processor 10 in order to calculate a preferred set of operations for execution of a certain task based of properties of objects. For example, weight and/or movability of objects is important for calculating an optimal rout and/or set of operations for cleaning a house or any other task involved with moving objects. Processor 10 may obtain features such as weight from the relevant object category and/or calculate, for example, the cost of moving an object such as a chair, table and/or piano. Thus, for example, processor 10 may calculate an optimal cost-effective solution, i.e. rout and/or set of actions, for performing a task.

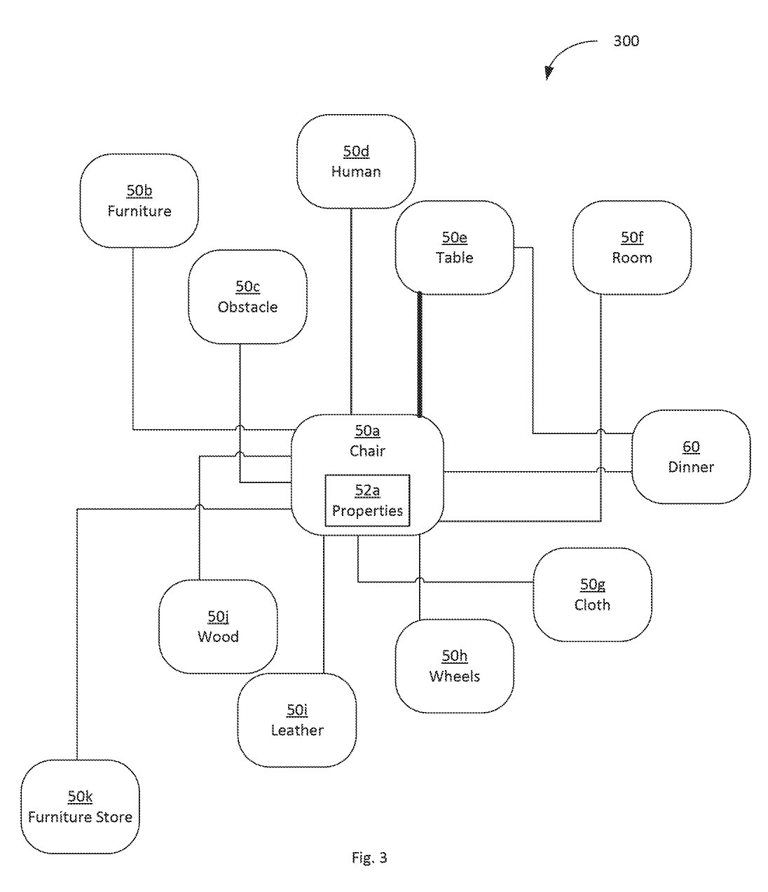

Reference is now made to FIG. 3, which is a schematic graph illustration of an exemplary portion 300 of object database 181, according to some embodiments of the present invention. Database portion 300 may include a plurality of object categories 50a-50k. Each object category may be associated with category features, such as properties 52a related to category 50a.

The object categories may include categories of physical objects such as, for example, chair, table, pen, car, door, or oven, as well as categories of concepts such as, for example, a tomato soup, washed and yet wet clothes, or a family dinner. A task in task database 182 may be defined by such conceptual object categories, for example as a goal of the task. For example, an object category dinner 60 may be a conceptual category, defining the concept of dinner. The category dinner 60 may also be a goal defining a task in task database 182.

Database portion 300 includes relations between object categories 50a-50k, indicated in FIG. 3 by connector lines between the object categories. In some cases, a relation may be by descendance, such as the relation between the category furniture 50b and the category chair 50a, which is a sub-category of the category furniture 50b. In some cases, a relation may be by descendance, such as the relation between the category table 50e and the category chair 50a.

Different types and/or levels of relations may be indicated differently in database 181. For example, each relation between the object categories may have a weight value according to the strength and/or type of the connection, illustrated, for example, by a heavier line connecting between the category table 50e and the category chair 50a. For example, the weight value may represent the probability that objects from the respective categories are related, for example that an object of category 50a is related to an object of category 50e. The weight value can dynamically change based on current events and/or conditions. For example, in case of an active task of preparing a family dinner, for example defined by the category dinner 60, the connection between the category chair 50a and the category table 50e is enhanced. This mechanism is similar to the attention mechanism in human brain, when dedicated search of the cat in the dark room (e.g. after hearing its meowing) results in higher probability to discover it faster than by just noticing it from relaxed gazing into the room.

Returning to FIG. 2, based on a set of features of an object identified in the sensory data, as indicated in block 230, processor 10 may determine if the object belongs to a related object category of database 181. As indicated in block 240, in case processor 10 finds in database 181 a related object category, processor 10 tags the corresponding sensory data with the corresponding object category ID and then updates the database with the tagged sensory data, as indicated in block 270. As indicated in block 250, in case processor 10 does not find in database 181 a related object category, processor 10 creates a new object category and tags the corresponding sensory data with the ID of the new object category and then updates the database with the tagged sensory data, as indicated in block 270. The tagged sensory data may be stored in a tagged data database 183 in database 18, for example indexed according to the object categories ID tags. The stored tagged sensory data may be used for further off-line processing, for example in order to determine features of materials and/or objects, features which may be stored with relation to the corresponding object categories.

An object category may include other categories, i.e. sub-categories which are defined by the same category and include further more specific definitions, e.g. include additional features required for matching a sub-category. Additionally, a category may have pre-stored features in object database 181, which are attributed by processor 10 to objects identified as belonging to the category. In case the set of features identified in the sensory data includes additional features further to the category features, as indicated in block 260, processor 10 may create an object sub-category that includes these additional features, and tag these additional features with the ID of the created sub-category and then updates the database with the tagged sensory data, as indicated in block 270.

Processor 10 may attribute permanency or movability to some object categories, i.e. tag the objects belonging to these categories as a permanent or movable obstacle. In some embodiments of the present invention, processor 10 may identify and tag each object as a permanent or movable obstacle, thus creating a map layer indicating which areas of the environment are navigable by autonomic machine 20 and where non-movable obstacles, which constitute non-navigable areas, are located. For example, processor 10 may identify an object as movable or permanent by object recognition, e.g. recognize an object as known objects with known properties. For example, processor 10 may identify an object by image processing as belonging to a certain category and tag the object as a permanent or movable obstacle according to the category.

In some embodiments of the present invention, objects with estimated and/or typical weight over a predefined threshold, such as heavy furniture, may be tagged by processor 10 as non-movable or as movable under certain conditions, e.g. a semi-permanent obstacle. Movable obstacles may include, for example, chairs, light furniture, various household objects, bicycles, TV-sets, suitcases, computers, seating puffs, and/or any other suitable movable objects. In some embodiments of the present invention, processor 10 may identify and tag accordingly autonomous object that move by themselves such as humans, animals, home pets, toys, robots, and/or any other suitable autonomous object.

In some cases, processor 10 may change tagging of an obstacle between permanent and movable. In some embodiments, processor 10 may generate specific instructions how to move an obstacle. For example, a locked door may be tagged as a permanent obstacle that can change its state and become movable. Once a door is unlocked, it may be moved from a closed state to an open state and vice versa, thus becoming a movable object.

In some embodiments of the present invention, processor 10 may tag a specific object as permanent or movable based on received sensor data. For example, autonomic machine 20 may navigate, for example in a domestic environment, and obtain and provide to processor 10 a stream of sensor data. For example, processor 10 identifies an object in the data-stream in different time frames in different positions or identifies the object in a certain location in only some of the time frames. Therefore, processor 10 tags this object as movable. In some embodiments, autonomic machine 20 may physically touch, push and/or move an object while navigating in the environment, sense the movement, and therefore tag this object as movable.

According to some embodiments of the present invention, data collected, stored and/or integrated by system 100 about objects located in its environment may facilitate performing of tasks in an optimized manner. For example, processor 10 may obtain and/or calculate, based on sensor and/or stored data, information such as weight, stiffness/softness, fragility and/or movability of objects involved in a certain tasks, for example in order to calculate a preferred order of operations and/or a preferred rout.

In some embodiments, processor 10 may calculate an optimal, fastest, most efficient and/or most economical manner of performing a task, i.e. of reaching a state B from an initial state A. For a task of transformation from state A to state B, processor 10 may calculate a path on the stored map, including actions and/or an order of actions, to minimize for example, the travel time and/or consumed energy. For example, in case the task is preparing a meal, an initial state A may be a set of products in the fridge and no meal on the table, and a final state B is a served dinner on the table. The optimality criteria may include a minimized amount of time and/or a minimized consumed energy during the preparation and the afterward cleaning, for example with a given set of dishes and/or quality level of the meal.

In some cases, in order to calculate an optimal path for a task, processor 10 may require data about properties of objects in the environment, for example in order to calculate, find and/or determine moving of which object consumes less energy, for example between a rolling chair and a table or a cupboard. Processor 10 may recognize an object based on received sensor data, and obtain from the database stored information about the object's properties. For example, processor 10 may recognize a cup on the table, estimating the cup's size and query a database to obtain properties of cups of the estimated size.

Task database 182 may store hierarchic task categories of tasks performable by machine 20, wherein each task may include a set of operations that may be controlled by controller 16. For example, a task of collecting the dirty clothes spread around an apartment may be decomposed into simpler actions up to basic actions such as advancing to a certain location and/or grabbing an object at a certain location. Each task in database 182 may be stored with indications as to relations to other tasks of database 182 and/or to object categories of object database 181. The set of operations for performing a task may be an optimal set of operations calculated by processor 10, as, described in detail herein. A task stored in task database 182 may also include and/or be related to a set of rules for performing the task, and/or processor 10 calculates the set of operations according to the set of rules. For example, the task of laundry may include rules regarding sizes, weights and colors of laundry items and regarding which detergents and/or washing programs should be used.

Task categories may include, for example, moving of objects, cleaning, laundry chores such as collecting laundry, putting laundry in a washing machine, moving laundry to the dryer, folding and moving it to the wardrobe, putting dirty dishes in a dish washer and putting clean dishes on dish shelves, moving furniture during cleaning of the house, ordering items such as toys spread around the house to the appropriate locations, manipulating with food for preparation of dinner, and/or any other suitable task. In some embodiments, a task may be stored in database 182 with instructions regarding when and/or in which conditions the task should be performed.

When identifying an object, as indicated in block 280, processor 10 may check whether task database 182 includes a task related to the identified object. For example, a task that involves the object, requires use of the object, requires moving of the object or requires any other operation with the object may be tagged as related to the object. As indicated in block 290, in case task database 182 includes a task related to the identified object, processor 10 may perform the related task if required and/or update the task parameters based on the new sensory data. The update may include, for example, update of the operations and/or the order of operations included in the task, the manner in which an operation is performed, and/or any other suitable parameter of the task.

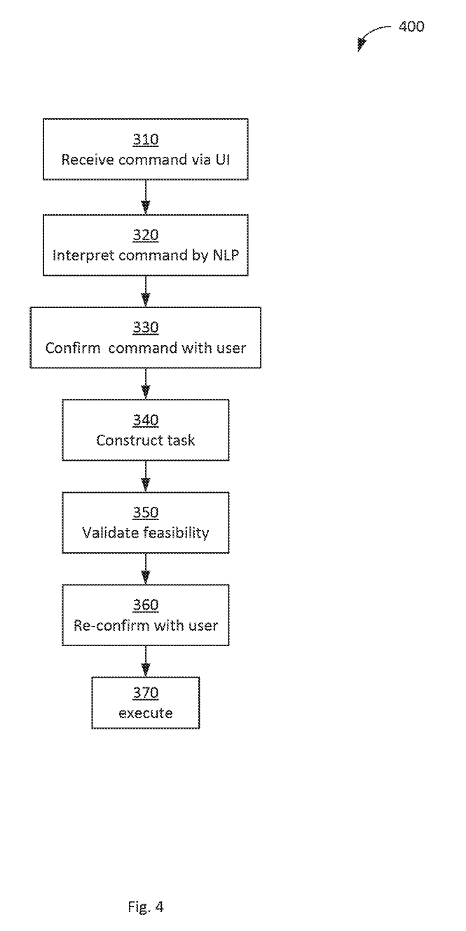

Reference is now made to FIG. 4, which is a schematic flowchart illustrating a method 400 for executing a task according to some embodiments of the present invention. As indicated in block 310, processor 10 may receive a command from a user, for example by a user interface (UI) 110. UI 100 may include a network interface to receive commands via digital communication such as via a cellular network, Wi-Fi, Bluetooth, TCP/IP and/or any other suitable network and/or protocol. User interface (UI) 110 may include a keyboard, buttons, voice user interface, video, emotion recognition, 3D scanners, laser scanners, and/or any other suitable user interface and/or command recognition method. As indicated in block 320, processor 10 may interpret the command, for example translate the command to objects and/or tasks stored in database 18, for example by a Natural Language Processor (NLP) 11 and a speech recognition engine 12. In some embodiments, in order to prevent erroneous actions, processor 10 may request a user to confirm the requested task, as indicated in block 330. For example, processor 10 may present the interpreted command to the user by UI 110, for example by generating and displaying text and/or generating and sounding speech, for example, by a speech generator 121. In some embodiments, if the interpreted command is erroneous, processor 10 may request the user to repeat the command and/or may perform a repeated interpretation process.

As indicated in block 340, once the interpreted command is confirmed, processor 10 may construct a work plan of how to execute the task, for example by calculating a preferred set of operations for execution of the task based of properties of objects, as described in detail herein. The set of operations may include for example ready-made instructions that may be stored on database 18 and/or searched for and downloaded by processor 10 from a network, cloud and/or a remote server. In the calculation process, processor 10 may identify the goal of the task, e.g. the desired target state, and properties of the involved objects in order to calculate an optimal path and/or optimal set of operations.

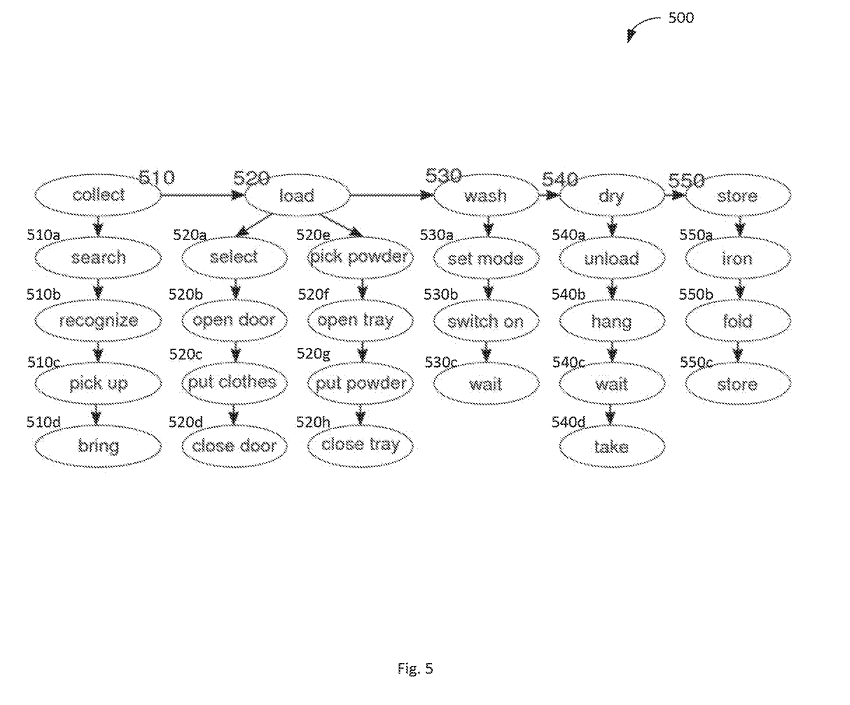

Reference is now made to FIG. 5, which is a schematic illustration of a task work plan, showing a task 500 decomposed into a set of operations, according to some embodiments of the present invention. Task 500 is decomposed into smaller tasks, for example major steps 510-550, each of the major steps decomposed to basic actions 510a-510d, 520a-520h, 530a-530c, 540a-540d and 550a-550c, respectively.

Returning to FIG. 4, in some embodiments, once the set of operations is calculated, processor 10 may validate the feasibility of the work plan, as indicated in block 350. For example, processor 10 may verify that all the necessary objects and/or resources are available and ready to use. For example, processor 10 may instruct autonomous machine 20 to explore the relevant environment to make sure the environment and/or required objects are available and ready for the task.

In some embodiments, as indicated in block 360, once the work plan is ready and/or validated, processor 10 may present the calculated plan to the user by UI 110, for example by text and/or by voice, and request the user's confirmation. In response, for example, the user may Confirm the plan, edit the plan, and/or reject the plan. In case the plan is not confirmed and/or rejected, processor 10 may request the user to edit the plan and/or may perform a repeated plan construction.

As indicated in block 370, for example once the work plan is validated and/or confirmed, processor 10 may execute the plan. For example, processor 10 may generate instructions for performing the required task according to the work plan, for example by an action generator engine 14, which may provide the instructions to controller 16. The work plan instructions may be stored in a command repository 141 for later use.

In some embodiments of the present invention, received and/or predefined instructions may be stored in command repository 141 for activation at a later time or event. For example, in some cases, once machine 20 encounters and/or senses a certain object, it performs a task related to this object stored in advance in repository 141.

In some embodiments of the present invention, processor 10 may identify based on sensory data that a certain task should be activated, and generate corresponding instructions for controller 16. For example, processor 10 may identify a stain, for example by identifying features related to a stain category in object database 181. Then, processor 10 may find in database 182 a task of cleaning a stain which require, for example, an immediate action and/or an action under certain conditions. If an immediate action is required and/or the conditions are fulfilled, processor 10 generates corresponding instructions for controller 14 to clean the stain. In some embodiments, repository 141 may store timed tasks, so that machine 20 activates performance of a task in a corresponding pre-scheduled time.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor, or a portable device such as a smart phone or a tablet computer, or a micro-processor, or a RISC processor, or a DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or electronic circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry. The processor and program may constitute the same apparatus, at least partially, such as an array of electronic gates, such as FPGA car ASIC, designed to perform a programmed sequence of operations, optionally comprising or linked with a processor or other circuitry.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. An environment exploration method comprising:
maintaining a database of object categories by:
receiving sensory data from sensors of an autonomic machine and obtaining from the sensory data features of objects; and
associating the obtained sensory data with corresponding object categories of the database, wherein the database stores a plurality of object categories associated with corresponding category features;
identifying categories of objects and the corresponding category features relevant to a required task;
calculating a work plan with a preferred set of operations for execution of the task based on the identified features; and
generating and transmitting to actuators of the autonomic machine instructions to perform the calculated preferred set of operations.

2. The method according to claim 1, comprising attributing the features obtained from the sensor data to the associated object category.

3. The method according to claim 1, comprising receiving the required command from a user, interpreting the command by a Natural Language Processor (NLP), validating the feasibility of the work plan and requesting a user to confirm the work plan.

4. The method according to claim 1, wherein calculating a work plan comprising decomposing the task into a hierarchic set of operations based on the identified category features.

5. The method according to claim 1, comprising determining if the obtained object features belongs to a related object category of the database, and in case a related object category is found in the database, tagging the corresponding sensory data with a corresponding object category identification and storing the tagged sensory data.

6. The method according to claim 5, wherein in case a related object category is not found in the database, creating a new object category, tagging the corresponding sensory data with an identification of the new category and storing the tagged sensory data.

7. The method according to claim 5, wherein in case a in case the set of features identified in the sensory data includes additional features further to the features of the found category, creating an object sub-category that includes these additional features, tagging these additional features with the identification of the created sub-category and storing the tagged sensory data.

8. The method according to claim 1, wherein the database of object categories stores categories of physical objects and categories of conceptual objects.

9. The method according to claim 8, wherein the conceptual objects are potential goals of tasks.

10. The method according to claim 8, wherein the database includes relations between object categories, wherein different types or levels of relations are indicated differently in the database, wherein each relation between object categories has a weight value according to the strength or type of the connection.

11. The method according to claim 10, wherein the weight value of relation between object categories represents the probability that objects from the respective categories are related.

12. The method according to claim 10, wherein the weight value dynamically changes based on current events or conditions.

13. An environment exploration system comprising:
a database of object categories storing a plurality of object categories associated with corresponding category features;
an autonomic machine having sensors and actuators; and
a processor configured to:
receive sensory data from the sensors of the autonomic machine and obtain from the sensory data features of objects;
associate the obtained sensory data with corresponding object categories of the database;
identify categories of objects and the corresponding category features relevant to a required task;
calculate a work plan with a preferred set of operations for execution of the task based on the identified features; and
generate and transmit to the actuators of the autonomic machine instructions to perform the calculated preferred set of operations.
